(19) United States
(12) Patent Application Publication
(10) Pub. No.: US 2023/0066862 A1
(43) Pub. Date: Mar. 2, 2023

(54) ELLIPTICAL MEMBERS

(71) Applicant: HEWLETT-PACKARD DEVELOPMENT COMPANY, L.P., Spring, TX (US)

(72) Inventor: Robert Paul Martin, Fort Collins, CO (US)

(73) Assignee: HEWLETT-PACKARD DEVELOPMENT COMPANY, L.P., Spring, TX (US)

(21) Appl. No.: 17/794,404

(22) PCT Filed: Jan. 31, 2020
(86) PCT No.: PCT/US2020/016279

§ 371 Date: Jul. 21, 2022

(51) Int. Cl. H02J 50/10

(52) U.S. Cl. CPC H02J 50/10; H02J 2310/22

(57) ABSTRACT

An example charge system may include a human interface device (HID) and a base station. An example HID may include a body member, an elliptical member, a rechargeable power supply, device circuitry, and a charge device embedded within the elliptical member. An example base station may include a housing having a raised, elliptical charge area and a charge device located within the housing at the charge area.

### BACKGROUND

Electronic devices designed as a form factor to be worn or held are increasingly common. Mobile devices, such as phones and tablets, have a hand-held form factor to use in a mobile environment. Wearable electronic devices are used in many industries including fitness and virtual reality (VR). Such devices are capable of enhancing an experience with electronic information and/or sensory-excitation during activity while worn.

### BRIEF DESCRIPTION OF THE DRAWINGS

FIG. 1 is a block diagram depicting an example human interface device (HID).

FIG. 2 is a block diagram depicting an example base station.

FIG. 3 is a block diagram depicting an example charge system.

FIG. 4 is a block diagram depicting components of an example HID.

FIG. 5 is an isometric view of an example HID.

FIG. 6 is an isometric view of an example charge system including an example base station and example HIDs.

FIG. 7 is an isometric view of an example charge system including an example base station and an example HID.

### DETAILED DESCRIPTION

In the following description and figures, some example implementations of human interface devices (HIDs), base stations, and charge systems are described. HIDs, base stations, and charge systems are electronic devices. Electronic devices may include circuitry, a combination of circuitry and executable instructions, a housing to contain the circuitry, and other functional physical parts to accomplish function. Wearable devices may include such components, including components to allow the device to be worn. For example, the wearable devices may include components that provide adjustability or otherwise adaptable to different body size, body shapes, and/or user preferences. Electronic devices may be operated in a mobile environment using a battery contained in the electronic device and then returned to a power source to charge the battery of the electronic device. The electronic devices discussed herein may include a rechargeable power supply, and a rechargeable power supply, as used herein, includes a battery, super capacitor, or other energy source containable within the electronic device. The rechargeable power supply may be discharged for use by the electronic device circuitry and charged by another power supply, such as another rechargeable power supply or a wall outlet.

An example HID may be a wireless, hand-held controller that is coupleable to a headset including a display to provide an enhanced reality (XR) experience. As used herein, XR generally includes technologies and experiences associated with virtual reality (VR), augmented reality (AR), and/or mixed reality (MR). In examples described herein, a “display” may be a device to present content visually. Example displays may include a screen such as a liquid crystal display (LCD) panel, an organic light-emitting diode (OLED) panel, a micro light emitting diode (μLED), or other display technology. In some examples, a display device may also include circuitry to operate the screen, such as a monitor scaler or display controller.

A base station, as used herein, is an electronic device that includes a charge device capable of providing power to a charge receiver. The base station includes a power supply, which may be an alternating current power supply or a rechargeable power supply. As discussed further herein, a base station may be used to transmit power (e.g., charge) the rechargeable power supply of a HID. Some HIDs include form factors with footprints that may not be compatible with substantially wireless charging devices having substantially flat charge areas, such as HIDs with circular hoops for use with XR location-tracking cameras. Thus, there appears to be a need for a base station with charging capabilities having a form factor compatible with HIDs having an elliptical section.

Various examples described below relate to providing charge capabilities to a HID with an elliptical member. The charge system may involve providing a base station that has an elliptical member complementary to an elliptical member of the HID to which the base station may be coupled. The complementary form factors may provide wireless charging capability and increase ease-of-use for charging the HI Ds, in particular in an entertainment facility that offers the uses of multiple XR systems for parties including a number of people.

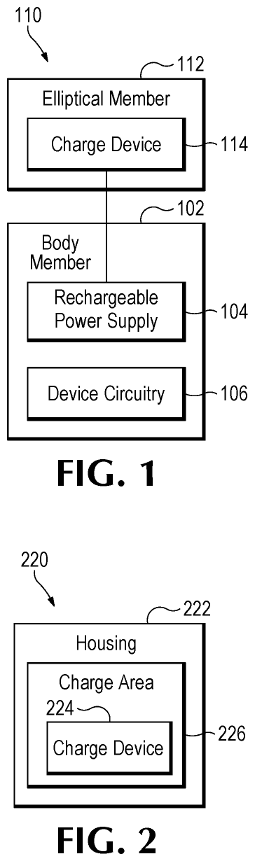

FIG. 1 is a block diagram depicting an example HID 110. The HID 110 generally includes a body member 102 and an elliptical member 112 coupled to the body member 102. The body member 102 may include housing for the electronics of the HID 110, such as the rechargeable power supply 104 and the device circuitry 106. In this manner, the device circuitry 106 and the rechargeable power supply 104 are located within the body member 102. The device circuitry 106 is coupled to the rechargeable power supply 104 such that the device circuitry 106 is provided power from the rechargeable power supply 104. Device circuitry, as discussed later, includes electronic circuitry useable by the HID 110 and directly coupled to the HID 110, such as a sensor, transmitter, electronic display, a printed circuit board, a light-emitting diode (LED), a motor, an accelerometer, a linear encoder, a camera, a gyroscope, and the like.

The elliptical member 112 is coupled to the body member 102. For example, the elliptical member 112 may be a housing protrusion or a separate device physically connectable to the body member 102 that includes a substantially elliptical shape. The elliptical member 112 may be circular, oval, conical, frustoconical, spherical, semi-spherical, ellipsoid, egg-shaped, or any other shape having a substantially elliptical contour. The elliptical member 112 may define an aperture. For example, the elliptical member 112 may be a hoop extending from the body member 102.

A charge device 114 may be embedded within the elliptical member 112. The charge device 114 may be a charge receiver, such as a metallic coil, that includes circuitry to receive a charge from a power source. The charge device 114 is coupled to the rechargeable power supply 104 located within the body member 102. For example, a charge coil may be electrically coupled to rechargeable power supply 104 to charge the rechargeable power supply 104. The charge device 114 may be located within and/or along the perimeter of the elliptical member 112. For example, a charge coil may be located within a frustoconical elliptical member where the charge coil includes multiple turns that spiral up along a perimeter of the frustoconical shape of the elliptical member (e.g., the turns of the charge coil may stack along the exterior perimeter wall of an elliptical member defining an aperture). The charge coil may be located on, in, or along the elliptical wall(s) of the elliptical member 112.

FIG. 2 is a block diagram depicting an example base station 220. The base station 220 generally includes a housing 222 and a charge device 226 within the housing 222. The charge device 226 may be a charge transmitter that includes circuitry to provide power to a charge receiver. The charge device 226 may be a charge coil located inside a raised portion of the housing designated as a charge area 224. The charge area 224 is elliptical in shape such that the raised portion is complementary or otherwise accepting of receiving an elliptical member of a HID, where the elliptical member contains a charge receiver to receive charge from the charge device 226 at the charge area of the base station. The elliptical charge area 224 may have an elliptic paraboloid shape, such as a hemisphere, that extends from a base plate of the base station 220. The base plate coupled to the charge area 224 may have a footprint larger than the charge area 224, such as to stabilize the protruding charge area 224, for example. The base plate may be thick enough to sustain the raised charge area 224 from the base plate and an elliptical member coupled to the charge area 224 (e.g., an elliptical member of a HID resting on the charge area 224).

The charge device 226 at the charge area 224 may include a charge coil with multiple turns aligned to layer along an interior perimeter of a raised edge of the charge area that complements alignment of turns of a charge coil in the exterior perimeter of the elliptical member of a HID. The charge coil may be located on, in, or along the raised wall(s) of the charge area. The turns of the charge coil may be stacked in an alignment along the same axis as the elliptical charge area. In some examples, the charge coil is perpendicular or oblique with respect to the base plate. In other example, the charge coil is aligned parallel with respect to the raised wall of the charge area.

The base station 220 may include an alignment mechanism, such as a magnet and/or detent of the housing, located at the charge area 224 to guide an elliptical member of a HID to reside in a supported position on the charge area 224. A detent, as used herein, is a protrusion or indentation.

The base station 220 may include a power supply coupled to the charge device 226. The power supply may receive alternating current (AC) power and converts the AC power to supply to the charge device 226 to allow that the charge device 226 to deliver power wirelessly to a HID, for example. The base station 220 may include a charge management controller coupled to the power supply. The charge management controller is circuitry or a combination of circuitry and executable instructions to activate power transfer when a HID is coupled to the base station at the charge area.

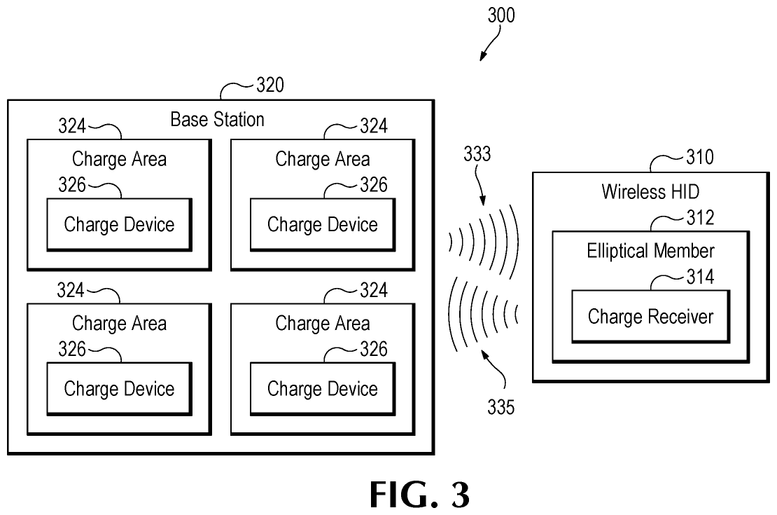

FIG. 3 is a block diagram depicting an example charge system 300. The charge system 300 generally includes a base station 320 and a HID 310. The charge system 300 wirelessly provides power 333 from the base station 320 to the HID 310 via complementary charge devices on the base station 320 and the HID 310. For example, the charge device 326 of the base station 330 (e.g., a charge transmitter of the base station 330) provides power to the charge receiver 314 of the wireless HID 310 when the elliptical member 312 of the wireless HID 310 is aligned with the elliptical charge area 324 or otherwise within a proximity threshold of the charge device 326 of the base station 320 (e.g., within a magnetic field limit corresponding to the charge coils of the charge receiver and the charge transmitter). A proximity threshold, as used herein, is a distance corresponding to a charging operation limit. For example, the proximity threshold may be a distance of the magnetic field of which wireless power may be transferred. In another example, the proximity threshold may be the thickness of the housing of the charge area and/or elliptical member of the HID when the elliptical member is in contact with the base station. In yet other examples, a proximity threshold may be set based on a method of pairing between the HID and the base station. In some examples, the charge device 326 and/or charge receiver 314 may be used as a sensor to identify proximity to the base station, such as using the strength of a magnetic field of interacting with a charge coil to indicate a distance. The base station 300 may include a charge status indicator operable to indicate a status of a charge operation. For example, the charge status indicator may be an acoustic device that emits a sound when the HID is within a proximity threshold to the base station 320 and ready for charging.

The base station 320 may include multiple charge areas 324 that are compatible with the HID. For example, the elliptical shape of each charge area 324 may be complementary to the shape of the elliptical member of the HID 310, and the charge device located at each charge area may be electrically compatible with the charge device of the elliptical member of the HID 310. In an example, the elliptical member of the base station 320 is radially complementary with the elliptical member of the HID 310 when the elliptical members have the same radius. In another example, the elliptical member of the base station 320 and the elliptical member of the HID 310 are radially complementary by being having an elliptical center of the HID elliptical member alignable with an elliptical center of the base station elliptical member.

An example wireless HID 310 of FIG. 3 has an elliptical member 312 that includes a charge receiver 314. For example, the elliptical member 312 may be a frustoconical hoop having a charge coil located inside the hoop. The hoop may have an internal circumference that is compatible with a size of a hemispherical structure of a charge area 324 of the base station 320. The elliptical member 312 of the wireless HID 310 and the elliptical area of the charge area 324 may also include a detent to guide mechanical and/or electrical connection between the devices. For example, the elliptical member 312 of the wireless HID 310 may have a first detent that is compatible with a second, complementary detent extending from a perimeter of the charge area 324 of the base station 320. In an example, the elliptical member 312 may be a hemispherical ring extending from a handle of the HID 310 with an indent at a location on the ring that is compatible with a protrusion extending from an outer surface on a hemispherical charge area 324 of the base station 320.

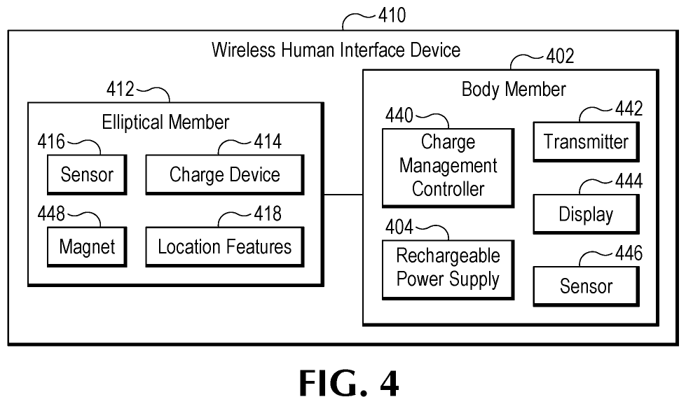

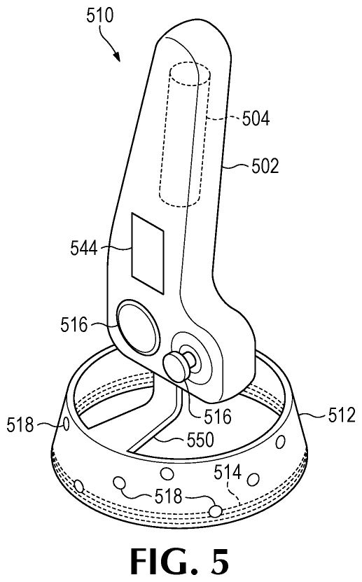

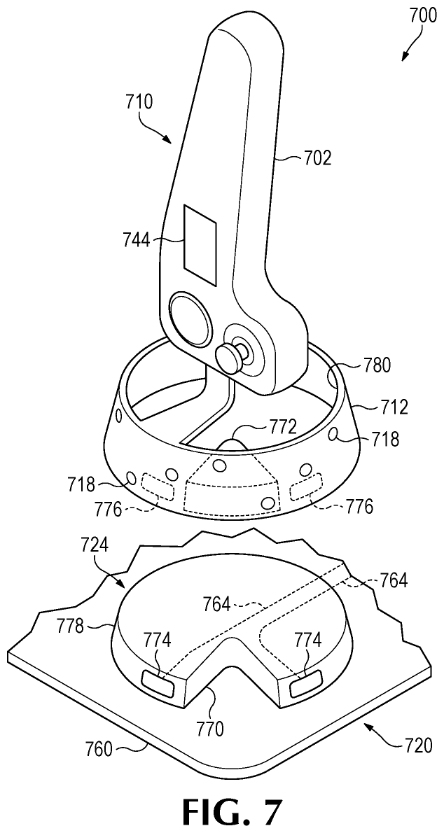

A charge device 326 (e.g., a charge transmitter) of the base station 320 may provide power to the charge receiver 314 of the wireless HID 310. A charge management controller may manage provision of the power between the charge device of the wireless HID 310 and the charge device of the base station 320. For example, the charge management controller may authorize provision of power when the elliptical member is physically or electrically keyed to the base station or when the HID is paired, via executable program instructions, with the base station over a personal area network, for example. In an example, the wireless HID 310 may provide communication signals 335 to the base station to indicate authorization and/or proximity to the base station 320. In some examples, the communication signals 335 and power signals 333 may be layered, embedded, or encoded on the same series of signals to provide power and communication simultaneous, such as by providing power at a first range of frequencies and providing communication at a second range of frequencies that do not overlap with the first range of frequencies. The charge management controller may cause the charge status indicator to produce a light corresponding to a state of charge of a rechargeable power supply of the HID 310. The description corresponding to FIG. 4 discusses the charge management controller in more detail. In some examples, electrical contacts are located on the surfaces of the elliptical member of the HID and the base station, such that the electrical contact of the HID and the electrical contact of the base station come into physical contact when the corresponding detents are aligned, and electrical signals and/or power may be transferred between devices via the electrical contacts. Indeed, contact between electrical contacts of the HID and the base station may allow for electrical communication and/or power transfer between devices via the electrical contacts. The description of FIG. 7 discusses the use of electrical contacts in more detail.

Referring to FIG. 4, FIG. 4 is a block diagram depicting components of an example HID 410. The HID 410 of FIG. 4 generally includes an elliptical member 412 and a body member 402. The body member 402 generally includes a rechargeable power supply 404, a charge management controller 440 to manage charging and discharging of the rechargeable power supply 404, and device circuitry powerable by the rechargeable power supply 404. Example device circuitry shown in FIG. 4 includes a transmitter 442, a display 444, and a sensor 446. The sensor 446 represents circuitry to collect information about the HID 410 or environment in which the HID resides. The sensor 446 may be any type of sensor, such as a temperature sensor, a location sensor, a movement sensor, a hall sensor, an acoustic sensor, an electrocardiogram sensor, a chemical sensor, an optical sensor, a pressure sensor, a galvanic skin response (GSR) sensor, a fingerprint sensor, and the like. The sensor 446 is coupled to the body member 402 and coupled to the transmitter 442. The sensor 446 generates input data, and the transmitter 442 transmits the sensor-generated input data to a host device. Example input data may include data corresponding to signals from the press of a button, location data, movement data, biometric data, and the like. The transmitter 442 is circuitry to transmit information from the HID 410 to a host device, such as transferring information from the sensor 446 to a desktop computer hosting a VR application. The display 444 includes a panel and circuitry to operate the panel. For example, the circuitry of the display 444 may cause the panel of the display 444 to present device information, such as charge level of the rechargeable power supply 404.

The elliptical member 412 may include circuitry and features to assist power transfer to the rechargeable power supply 404 as well as circuitry and features to use the HID 410 in an XR environment. FIG. 4 depicts some example circuitry and features of the elliptical member 412, including a charge device 414, a sensor 416, a magnet 448, and location features 418. The charge device 414 may be the same as charge device of FIG. 1 and, for brevity, the description is not repeated in its entirety.

The sensor 416 within the elliptical member 412 may include circuitry to identify proximity to a base station capable of recharging the rechargeable power supply 404. For example, the HID 410 may pair with a particular one of multiple charge areas located on a base station using the circuitry of the sensor 416 to transmit pairing data, such as through near-field communication, and a charge management controller 440 may utilize the proximity information to determine whether to provide charge to the HID 410. In this manner, the sensor 416 of the elliptical member 410 may assist transfer of power between the base station and the rechargeable power supply 404 within the body member 402. In an example, the charge management controller 440 may not allow power to supply until the sensor 416 indicates the charge device 414 is authorized to be charged and/or within a proximity threshold with respect to a charge area of a base station.

The magnet 448 of the elliptical member 412 may couple to a magnet or metallic part of the base station to assist coupling and alignment of the elliptical member 412 to the charge area of a base station. The magnet 448 represents a feature of the elliptical member 412 that assists alignment of the elliptical member 412 to a base station so that power is provided to the charge device 414.

The location features 418 on the elliptical member 412 may be used by XR devices, such as cameras, to identify the location and/or orientation of the HID. The location features 418 may be light-emissive devices, such as a light-emitting diodes (LEDs) or electroluminescent material. The location features 418 may provide location information, such as to a tracking camera, when the HID is in use during an XR experience (e.g., not docked), and the location features 418 may indicate a charge status when the HID is docked on a base station. In that example, the location features 418 may be controlled by a charge management controller 440 to indicate a level of charge of the rechargeable power supply 404. For example, half of the LEDs may light up to indicate a 50% charge when the HID 410 is docked to the base station. In another example, the LEDs may be coordinated substantially linearly and light up a number of LEDs in a line indicative of the charge amount. In yet another example, the LEDs may turn red to indicate low charge level, flash at a particular rate to indicate the rechargeable power supply 404 is receiving a charge from the base station, and change to green to indicate the rechargeable power supply 404 is fully charged.

The charge management controller 440 may coordinate power transfer between the HID 410 and a base station and may coordinate circuitry associated with power transfer, such as operating the display 444 or location features 418 to indicate the charge state. The charge management controller 440 of FIG. 4 represents a combination of circuitry and executable instructions. The executable instructions of the charge management controller 440 include a control program to operate a component according to charge operation defined by the control program and may include a control program to operate a component according to operations related to charging. For example, the display 444 may be operated by the charge management controller 440, and the control program of the charge management controller 440 includes executable instructions to cause the display 444 to present a charge level indicator associated with the charge level of the rechargeable power supply 404.

The charge management controller 440 may include a memory resource and a processor resource. The memory resource may contain a set of instructions that are executable by the processor resource. The set of instructions are operable to cause the processor resource to perform operations of the HID 410 when the set of instructions are executed by the processor resource. The processor resource may carry out a set of instructions to execute any appropriate operations discussed herein or any other appropriate operations associated with the components and functions of the HID 410.

A processor resource is any appropriate circuitry capable of processing (e.g., computing) instructions, such as one or multiple processing elements capable of retrieving instructions from a memory resource and executing those instructions. For example, the processor resource 222 may be a central processing unit (CPU) that enables charging by fetching, decoding, and executing program instructions from the memory resource. Example processor resources include at least one CPU, a semiconductor-based microprocessor, a programmable logic device (PLD), and the like. Example PLDs include an application specific integrated circuit (ASIC), a field-programmable gate array (FPGA), a programmable array logic (PAL), a complex programmable logic device (CPLD), and an erasable programmable logic device (EPLD). A processor resource may include multiple processing elements that are integrated in a single device or distributed across devices. A processor resource may process the instructions serially, concurrently, or in partial concurrence.

A memory resource represents a medium to store data utilized and/or produced by the HID 410. The medium is any non-transitory medium or combination of non-transitory media able to electronically store data. For example, the medium may be a storage medium, which is distinct from a transitory transmission medium, such as a signal. The medium may be machine-readable, such as computer-readable. The medium may be an electronic, magnetic, optical, or other physical storage device that is capable of containing (i.e., storing) executable instructions. A memory resource may be a non-volatile memory resource such as read-only memory (ROM), a volatile memory resource such as random-access memory (RAM), a storage device, or a combination thereof. Example forms of a memory resource include static RAM (SRAM), dynamic RAM (DRAM), electrically erasable programmable ROM (EEPROM), flash memory, or the like. A memory resource may include integrated memory such as a hard drive (HD), a solid-state drive (SSD), or an optical drive. A memory resource may be said to store program instructions that when executed by a processor resource cause the processor resource to implement functionality of the HID 410 (or the base station for a charge management controller located in the base station). A memory resource may be integrated in the same device as a processor resource or it may be separate but accessible to that device and the processor resource. A memory resource may be distributed across devices.

In the discussion herein, the charge management controller 440 has been described as circuitry or a combination of circuitry and executable instructions. Such components may be implemented in a number of fashions. The instructions residing on a memory resource may comprise any set of instructions to be executed directly (such as machine code) or indirectly (such as a script) by a processor resource. In some examples, the charge management controller 440 may include executable instructions as part of an installation package that when installed may be executed by a processor resource to perform operations of the ID 410

FIG. 5 is an isometric view of an example HID 510. The HID of FIG. 5 generally includes a body member 502, a battery 504, a display 544, sensors 516, an elliptical member 512, a charge coil 514, and location features 518. The body member 502 includes a housing for the battery 504 and device circuitry and includes components such as the display 544 and sensors 516. The housing of body member 502 is designed to be a handle and may be adapted to be gripped by a hand of a user as well as contain device circuitry, such as environment sensors and user-input sensors. The example sensors shown in FIG. 5 include a joystick and a button that are capable of generating input data based on user interactions with the joystick and/or button.

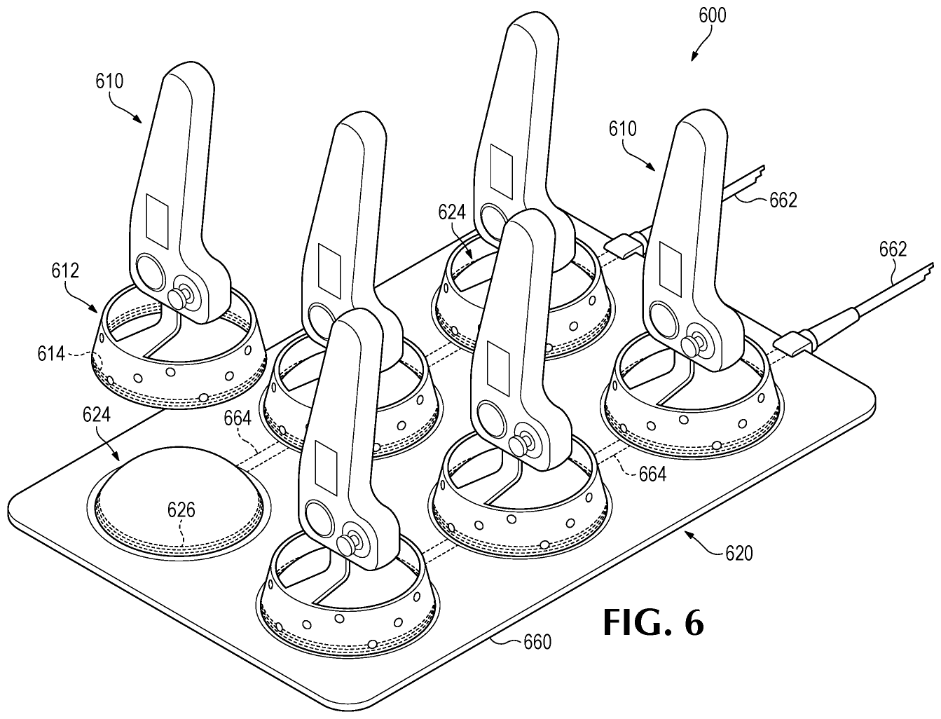

The elliptical member 512 of FIG. 5 is depicted as a ring having a frustoconical shape where the elliptical surface facing away from the body member has a larger diameter than the elliptical surface facing towards the body member. The elliptical member 512 is connected to the body member 510 by a support member 550. The support member 550 extends from an end of the body member and couples to a section of the interior perimeter of the elliptical member 512. The support member 550 may include electrical connections (not shown) between the components of the elliptical member 512 and the body member 502. Location features are located around the exterior and/or interior of the elliptical member 512. The thickness of the ring of the elliptical member 512 may be large enough to include a charge device, such as a charge coil 514 that loops around the ring. The charge coil 514 is located adjacent the elliptical surface facing away from the body member 502, which, as is depicted in FIG. 6-7, may be the surface to be in contact with a charge are of a base station. In this manner, the charge device 514 is located in the elliptical member 512 rather than in the body member 504.

The charge device 514 is electrically connected to the battery 504 to supply power from the charge device 514 to the battery 504 during charging operations. The battery 504 is electrically connected to the other device circuitry, such as display 544 and sensors 516, to provide power from the battery 504 to the device circuitry. Any other number of type of sensors, shapes, features, and other components may be implemented on the HID and the elements of FIGS. 5-7 are merely an example of the number and types of components and features implementable with a charge system.

FIG. 6 is an isometric view of an example charge system 600 including an example base station 620 and example HIDs 610. The example HIDs 610 are the same as the example HID of FIG. 5. The base station 620 depicted in FIG. 6 includes a base plate 660, two input power sources 662 (such as cables to plug into wall adapters) coupled to the base plate 660, and six charge areas 624 raised from the base plate 660. The six charge areas are electrically coupled using electrical connections 664. In some examples, the charge areas may be directly electrically connected to a power supply, such as connected via a universal serial bus (USB) cable to supply 5 volts from a USB adapter. In other examples, a charge management controller may manage or otherwise determine delivery of power from the electrical inputs 662 to any number of the charge coils 626 of the charge areas 624 via electrical connections 664.

The charge areas 624 include a plurality of hemispherical structures. In some examples, the charge areas may be substantially complete spheres. The shape of the elliptical member 614 is complementary to the hemispherical structure of the charge area 624 such that the elliptical member 612 can rest on or adjacent to the charge area. In particular, the charge coil 614 of the HID 610 may align adjacent to a charge coil 626 at the charge area 624 of the base station 620. The shapes of the elliptical member 612 of the HID 610 and the elliptical member of the base station 620 are complementary. As examples, the shape of the elliptical members 612 and 624 may substantially match, the elliptical charge area 624 may be slightly smaller in diameter than elliptical member 612 of the HID 610, the elliptical member 612 of the HID 610 may be slight smaller in diameter than the elliptical charge area, or the elliptical member 612 of the HID 610 may make centric contact with the charge area of the base station 620.

The hemispherical structure may act as an alignment feature such that the elliptical member 612 is positioned appropriately on the base station 620 to facilitate charging from a charge coil 626 of the charge area 624 to the charge coil 614 of the elliptical member 612. Alignment may be facilitated by the hemispherical shape by fitting the elliptical member 612 around the perimeter of hemispherical structure or if the elliptical member 612 contacts the hemispherical structure (e.g., the diameter of the elliptical member may be less than the diameter of the widest part of the hemispherical structure). In the latter example, the charge coil 626 of the charge area 624 may be located above the base plate 606 and within the hemispherical structure and located at the approximate planar location to where the charge coil 614 is located when the elliptical member 612 contacts the charge area 624. In this manner, the base station 620 includes a plurality of hemispherical structures being complementary to receive an elliptical member of a wireless HID and a plurality of charge devices located within the hemispherical structures to provide power to the charge receiver of the wireless HID.

The hemispherical charge areas 624 may include a charge status indicator. For example, the housing of the charge area 624 may be partially translucent to allow light from an LED through, have a coating of electroluminescence material, or otherwise capable of providing a light to indicate the status of charge operations of the base station 620 and/or level of charge of the rechargeable power supply of the HID 610. For example, a light-emissive device within the charge area 624 may light up the housing at the charge area 624 in a red color to indicate the HID 610 is connected, light up in the housing at the charge area 624 in an orange color to indicate the HID 610 is charging, and light up the housing at the charge area 624 in a green color to indicate the rechargeable power supply of the HID 610 is fully charged.

FIG. 7 is an isometric view of an example charge system 700 including an example base station 720 and an example HID 710. The example HID 710 of FIG. 7 generally includes components similar to the example HID 510 of FIG. 5 and includes an alignment feature (e.g., detent 772) and electrical contacts 776 on the interior of the ring of the elliptical member 712. The charge system 700 includes a base station 720 with a base plate 760 having a raised charge area 724. The raised charge area 724 includes a wall 778 that has a complementary shape to the interior wall 780 of elliptical member 712 of the HID 710, such that the elliptical member 712 can slide onto and/or around the raised charge area 724.

The elliptical member includes a detent 772 located on the interior of the elliptical member 712 of the HID 710. The elliptical member 712 may generally be hemispherical ring or frustroconcical shape extending from a handle (e.g., body member 702) of the wireless HID 710. The detent 770 of the perimeter of the charge area of the base station 720 has a complementary shape to the detent 772 to form an alignment interface. In this example, the wireless HID 710 may be spun around the center of the raised, elliptical charge area 724 until the detent 772 of the HID 710 aligns with the detent 770 of the base station 720 and allows the elliptical member to come closer to the base plate 760 and align electrical contacts 776 of the HID 710 with the electrical contacts 774 of the base station 720.

The electrical contacts 774 and 776 may be curved along the same curvature as the wall 780 of elliptical member of the HID 710 and/or the wall 778 of the raised, charge area 724. In other examples, the electrical contacts may be substantially flat and recessed in or protruding from the walls 780 and 778. Magnets may also be located on walls 778 or 780 to assist alignment. In some examples, electrical contacts 774 and 776 are conductive magnets capable of transferring power from to the rechargeable power supply of the HID 710.

Power may be provided from the power source to the electrical contacts 774 via electrical connections 764, and power may be received by the HID 710 via connection of the electrical contacts 776 with the electrical contacts 774 of the base station 720. In some examples, the electrical contacts may act as a detent, such as recessed or protruding charge contacts. In some examples, the detent interface may be supportive as well as electrically keyed. For example, the hemispherical charge area may include a planar rim along the exterior of the hemisphere that complements an elliptical surface facing away from the body of the HID 710 and sustains the HID 710 on the hemispherical charge area. In this manner, the elliptical member 712 of the HID 710 may be keyed with a detent to allow for alignment and/or power transfer between the base station 720 and the HID 710.

All the features disclosed in this specification (including any accompanying claims, abstract and drawings), and/or all the elements of any method or process so disclosed, may be combined in any combination, except combinations where at least some of such features and/or elements are mutually exclusive.

The terms “include,” “have,” and variations thereof, as used herein, mean the same as the term “comprise” or appropriate variation thereof. Furthermore, the term “based on,” as used herein, means “based at least in part on.” Thus, a feature described as based on some stimulus may be based only on the stimulus or a combination of stimuli including the stimulus. The article “a” as used herein does not limit the element to a single element and may represent multiples of that element. Furthermore, use of the words “first,” “second,” or related terms in the claims are not used to limit the claim elements to an order or location, but are merely used to distinguish separate claim elements.

The present description has been shown and described with reference to the foregoing examples. It is understood that other forms, details, and examples may be made without departing from the spirit and scope of the following claims.

What is claimed is:

1. A human interface device (HID) comprising:
a body;
a rechargeable power supply located within the body;
device circuitry coupled to the rechargeable power supply, the rechargeable power supply to provide power to the device circuitry;
an elliptical member coupled to the body, the elliptical member defining an aperture; and
a charge coil embedded within the elliptical member, the charge coil electrically coupled to rechargeable power supply to provide power to the rechargeable power supply.

2. The HID of claim 1, wherein:
the elliptical member is frustoconical; and
the charge coil includes multiple turns that spiral up along the frustoconical shape of the elliptical member.

3. The HID of claim 1, further comprising:
a sensor within the elliptical member, the sensor to identify proximity to a base station capable of recharging the rechargeable power supply.

4. The HID of claim 1, further comprising:
location features on the elliptical member, the location features to indicate a level of charge of the rechargeable power supply when the HID is docked on a base station and indicate location information when the HID is not docked on the base station.

5. The HID of claim 1, further comprising:
a magnet in the elliptical member, the magnet to provide alignment with a base station.

6. The HID of claim 1, further comprising:
a charge management controller to coordinate power transfer between the HID and a base station.

7. The HID of claim 6, further comprising:
a display;
wherein the charge management controller includes executable instructions to cause the display to present a charge level indicator corresponding to a level of charge of the rechargeable power supply.

8. The HID of claim 1, wherein the device circuitry includes:
a sensor coupled to the body, the sensor to generate input data; and
a transmitter coupled to the sensor, the transmitter to transmit the input data to a host device.

9. A base station comprising:
a housing having a charge area, the charge area being a raised, elliptical member of the housing and having an elliptic paraboloid shape; and
a charge coil within the housing at the charge area.

10. The base station of claim 9, further comprising:
an alignment magnet located at the charge area; and
a base plate coupled to the charge area, the base plate having a footprint larger than the charge area, the charge area being raised from the base plate and the charge coil including multiple turns aligned to layer along an interior perimeter of a raised edge of the charge area.

11. The base station of claim 9, further comprising:
a power supply coupled to the charge coil, the power supply to receive alternating current (AC) power and convert the AC power to supply to the charge coil; and
a charge status indicator operable to indicate a status of a charge operation.

12. The base station of claim 11, further comprising:
a charge management controller coupled to the power supply, the charge management controller to:
activate power transfer when a human interface device (HID) is coupled to the base station at the charge area; and
cause the charge status indicator to produce a light corresponding to a state of charge of a rechargeable power supply of the HID.

13. A charge system, comprising:
a wireless human interface device (HID) having an elliptical member, the elliptical member including a charge receiver; and
a base station comprising:
a plurality of hemispherical structures, a first hemispherical structure of the plurality of hemispherical structures being complementary to the elliptical member of the wireless HID; and
a plurality of charge transmitters, a first charge transmitter located within the first hemispherical structure, the first charge transmitter to provide power to the charge receiver of the wireless HID when the elliptical member of the HID is within a proximity threshold of the first charge transmitter.

14. The charge system of claim 13, comprising:
a first detent located on the elliptical member of the wireless HID, the elliptical member being a hemispherical ring extending from a handle of the wireless HID; and
a second detent extending from a perimeter of the charge area of the base station, the second detent complementary to the first detent of the wireless HID.

15. The charge system of claim 13, comprising:
a charge management controller to manage provision of power between the wireless HID and the first charge coil;
a first electrical contact located on the first detent; and
a second electrical contract located on the second detent, the first electrical contact and the second electrical contact to be in electrical contact when the first detent and second detent are aligned.
